(19) United States
(12) Patent Application Publication
(10) Pub. No.: US 2023/0241758 A1
(43) Pub. Date: Aug. 3, 2023

(54) AUXILIARY DEVICE FOR POWER TOOL

(71) Applicant: INGENIO TECHNOLOGY CO., LIMITED, Chai Wan (HK)

(72) Inventor: Wai Hang Raymond CHU, Chai Wan (HK)

(21) Appl. No.: 17/587,982

(22) Filed: Jan. 28, 2022

(51) Int. Cl. B25H 1/00; B25F 5/02; G01C 9/02; G01S 17/08

(52) U.S. Cl. CPC B25H 1/0092; B25F 5/02; G01C 9/02; G01S 17/08

(57) ABSTRACT

An auxiliary device for power tool having a power tool and rangefinder, the rangefinder being attached to/built in the power tool for distance measurement during the operation. The rangefinder includes at least a distance sensor set toward the operation direction of the power tool, a screen for showing the distance data of the distance sensor, and a control circuit connecting with the distance sensor and the screen for calculating the distance and displaying the distance data on the screen. A case, level meter, metal detector, and light sensor are also provided.

### FIELD OF THE INVENTION

The present invention relates to power tool, and more specifically to auxiliary device for improving the function of the power tool.

### BACKGROUND OF THE INVENTION

Power tools, such as electric drill, saw, impact driver, etc., are very popular tools for home maintenance. But while power tool is operating, it will produce dust and it is potential hazard to human health. Therefore, power tools should be equipped with a device that can prevent dust from entering the surrounding environment, so that the operator will not be exposed to excessive dust when working.

At present, the sander on the market uses a fan installed in the sander shell to suck the debris or dust generated during the grinding process into the dust collector installed on the sander shell through the dust suction hole on the bottom plate of the sander Go into the filter device, so as to play the purpose of collecting debris or dust. The traditional dust collecting and filtering device will be provided with a filter in it to filter the dust, but the filter of this kind of dust collecting and filtering device is installed on the upper cover of the dust collecting and filtering device, which is inconvenient to install and replace.

### SUMMARY OF THE INVENTION

In view of the aforesaid drawbacks of the prior art, the present invention provides an auxiliary device for power tool, when it is necessary, user can plug the auxiliary device to the power tool for measurement dimensions to improve better operation.

Auxiliary device for power tool comprising: a power tool, and a rangefinder, the rangefinder is attached to/built in the power tool for distance measurement during the operation; the rangefinder includes at least a distance sensor set toward the operation direction of the power tool, a screen for showing the distance data of the distance sensor and a control circuit connecting with the distance sensor and the screen for calculating the distance and displaying the distance data on the screen.

Further, includes a case for embedding the distance sensor, the control circuit and the screen inside; an installation base is mounted on the surface of the power tool; the case is detachably installed on the base.

Further, the installation base is mounted to the power tool by screw.

Further, the surface of the case sets a buckle slot and the installation base sets an elastic buckle to clasp with the buckle slot.

Further, includes a level meter for detecting level of the power tool and displaying level data on the screen, the level meter connect to the control circuit.

Further, includes a metal detector for detecting whether there is metal material embedded inside and display warning signal to user.

Further, includes a lighting fixture, which connects to the control circuit for turning on/of or brightness adjustment.

Further, includes a light sensor, which connects to the control circuit for detecting the environment light and control the lighting fixture.

Further, includes a chamber inside the shell of the power tool for building in the rangefinder, holes are set toward the operation direction of the power tool for installation of distance sensor; and the screen is mounted on the shell.

The invention has the following advantages: the rangefinder includes light sender which can emit laser or inferred to the surface and then reflect back to optical receiver of the distance sensor for calculation the distance and the distance in real-time will show on the screen for user reference. The level meter is a general device for measuring the anger between the tool and the operation surface to help user controlling the direction. With these auxiliary devices, user can easily get information of how the processing of power tool's operation and get the work done in perfect.

### BRIEF DESCRIPTION OF THE DRAWINGS

Below are explanations of the invention combining with drawings.

FIGS. 1 and 3 are perspective views of the present invention.

FIG. 2 is the front view of the present invention.

In the figures: 1. the power tool, 2. distance sensor, 3. the screen, 4. the case 5. the installation base, 6. the buckle slot, 7. the elastic buckle, 8. the lighting fixture.

### DESCRIPTION OF THE EMBODIMENTS

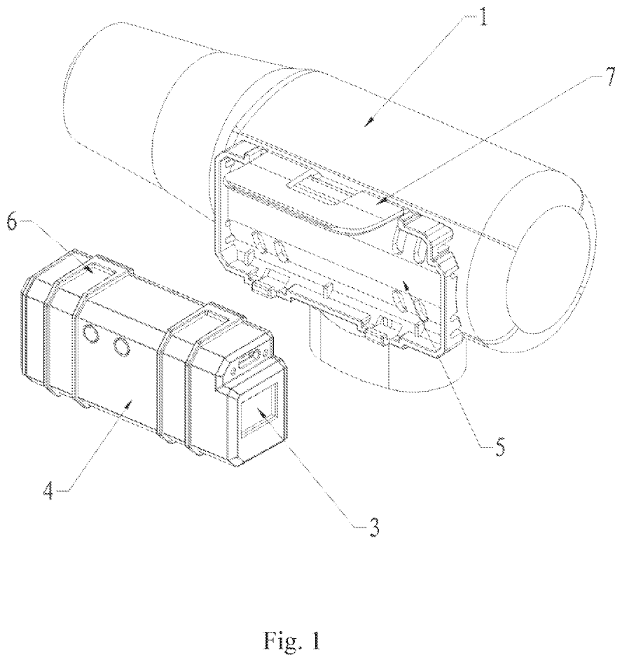

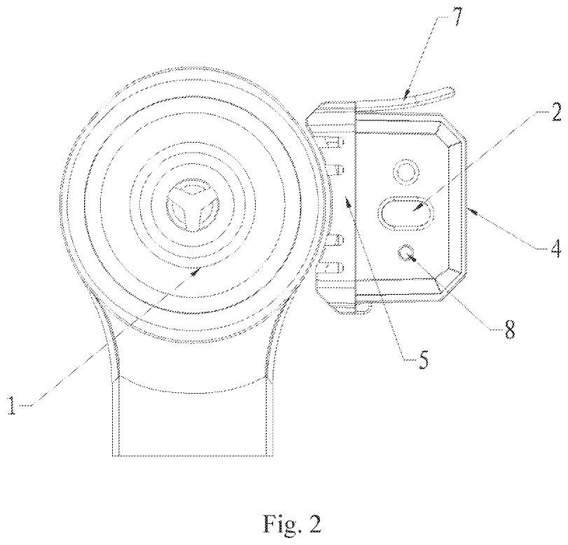

Refer to FIG. 1 and FIG. 2, the auxiliary device for power tool 1 comprises a rangefinder and it is attached to the power tool 1 for distance measurement during the operation, so that user can get the information of how deep the power tool 1 has processing. Comparing with using ruler for the measurement, the rangefinder is much more accurate. If the rangefinder has control port connected to the controller of power tool 1, the rangefinder can also send out signal to the controller for stopping the power tool 1 when the set depth or distance has reached. The rangefinder comprises a distance sensor 2 and a screen 3. The distance sensor 2 generally includes at least one light sender to emit laser or inferred to the surface and then light reflect back to optical receiver of the distance sensor 2 for calculation the distance. The light sender and the optical receiver set toward the operation direction of the power tool 1. The control circuit is basically a MCU, the light sender and the optical receiver connects to the I/O of MCU, MCU will calculate the phase difference or flight of time between sender and receiver to calculate the distance. Before the operation of power tool 1, user can start the distance sensor 2 to get the initial distance and set it as zero, and then begin the operation, user can read the real-time depth or distance on the screen 3.

For easily installing the auxiliary device to the exiting power tool 1, there is a case 4 for embedding the distance sensor 2, the control circuit and the screen 3 inside. Then an installation base 5 is mounted on the surface of the power tool 1. The case 4 can be installed or detached to the base 5 according to the need of user. The installation base 5 can be glued or tied to surface of the power tool 1. Most of the power tool 1 vibrates during working, so we prefer to use screw to fix the installation base 5 to prevent any moment between auxiliary device and power tool 1.

Further, for easily plug or unplug the auxiliary device to the power tool 1, the surface of the case 4 sets a buckle slot 6 and accordingly the installation base 5 sets an elastic buckle 7 to clasp with the buckle slot 6. When the case 4 plugs into the installation base 5, the elastic buckle 7 will clasp the buckle slot 6 to fix the case 4. Otherwise, user can push the elastic buckle 7 and release the buckle slot 6 from the elastic buckle 7, then take down the case 4.

In generally, keeping the power tool 1 operating in the horizontal direction is very important. So we provide a level meter as an auxiliary device. The level meter can use a gyroscope chip connecting to I/O of MCU for detecting level of the power tool 1. Also the level data can be displayed on the screen 3.

Further, a metal detector can be one of the auxiliary devices for detecting metal material, such as user can use the power tool 1 moving on the wall to detect the distribution of wires embedded in the wall.

Considering the usage of different environment, such as in dark, usually user will use a light. But user cannot free the hands to hold the light during operating the power tool. So a lighting is designed for more convenient. User can turn on/off, adjust brightness of the lighting manually. Further, inventor also design a light sensor. The light sensor connects to the control circuit for detecting the environment light and when it is dark enough, the control circuit will turn on the lighting fixture 8 automatically.

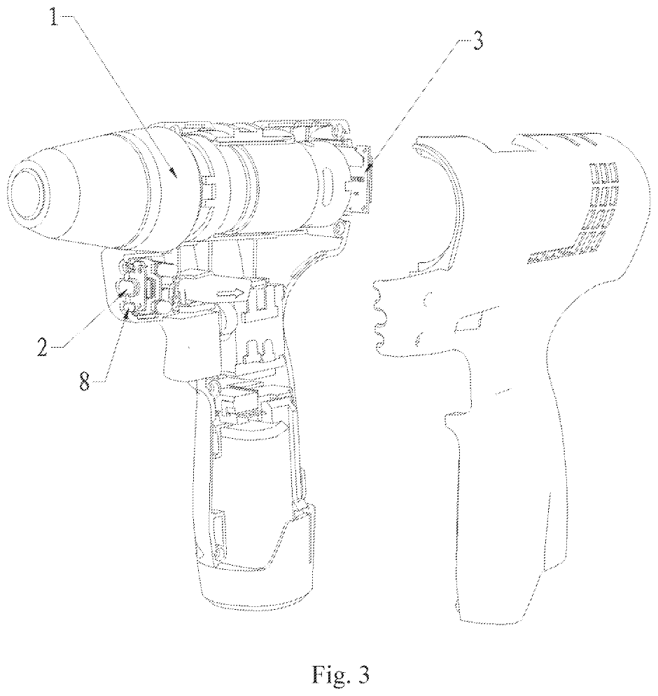

Generally, the auxiliary device can be an add-on to exiting power tool. Also, all above functions can be built in a new designed power tool, refer to FIG. 3. We will reserve a chamber 9 inside the shell of the power tool for installing the rangefinder, the level meter, the metal detector, and the lighting fixture. There are holes set toward the operation direction of the power tool 1 for the distance sensor 2 and the lighting fixture 8. Also the screen 3 is mounted on the shell for user's inspection.

1. An auxiliary device for power tool comprising: a power tool, and a rangefinder, the rangefinder is attached to/built in the power tool for distance measurement during the operation; the rangefinder includes at least a distance sensor set toward the operation direction of the power tool, a screen for showing the distance data of the distance sensor and a control circuit connecting with the distance sensor and the screen for calculating the distance and displaying the distance data on the screen.

2. The auxiliary device for power tool of claim 1, further comprising a case for embedding the distance sensor, the control circuit and the screen inside; an installation base is mounted on the surface of the power tool; the case is detachably installed on the base.

3. The auxiliary device for power tool of claim 2, wherein the installation base is mounted to the power tool by screw.

4. The auxiliary device for power tool of claim 2, wherein the surface of the case sets a buckle slot and the installation base sets an elastic buckle to clasp with the buckle slot.

5. The auxiliary device for power tool of claim 1, further comprising a level meter for detecting level of the power tool and displaying level data on the screen, the level meter connect to the control circuit.

6. The auxiliary device for power tool of claim 1, further comprising a metal detector for detecting whether there is metal material embedded inside and display warning signal to user.

7. The auxiliary device for power tool of claim 1, further comprising a lighting fixture, which connects to the control circuit for turning on/of or brightness adjustment.

8. The auxiliary device for power tool of claim 7, further comprising a light sensor, which connects to the control circuit for detecting the environment light and control the lighting fixture.

9. The auxiliary device for power tool of claim 1, further including a chamber inside the shell of the power tool for building in the rangefinder, holes are set toward the operation direction of the power tool for installation of distance sensor; and the screen is mounted on the shell.
